(19) United States
(12) Patent Application Publication
(10) Pub. No.: US 2004/0112460 A1
(43) Pub. Date: Jun. 17, 2004

(54) Filling machine

(76) Inventor: Garbriele Stocchi, Parma (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/471,231

(22) PCT Filed: Feb. 5, 2002
(86) PCT No.: PCT/IB02/00346

(30) Foreign Application Priority Data
Mar. 14, 2001 (IT) BO2001A000136

(51) Int. Cl. B67C 3/00

(52) U.S. Cl. 141/144

(57) ABSTRACT

Improvements to isobaric aseptic filling machines characterized by the fact that the processing fluids are not contained in a rotating tank but in a fixed tank (1). Such improvements also include a number of coil tubes (8) generating high flow resistance during the filling phase of the process fluid.

### FIELD OF THE ART

The present invention concerns bottling plants, especially for gassed liquids. International classification B67 g.

### STATE OF THE ART

Bottling plants with filling machines equipped with rotating tanks are already known.

The following problems still need be solved:

realizing simplified filling machines without rotating tanks;

modulating the filling process with a starting transitory phase at increasing filling speed and a final transitory phase at decreasing final phase;

discharging of gas and residuals through conduits separated by the processing fluids in order to avoid bacterial contamination;

The filling machines presented in this invention solves all the problems mentioned above proposing an extremely simple and affordable realization, together with a high operating reliability.

### DESCRIPTION

The invention is now disclosed in details, referring to the attached drawings as a not restrictive example.

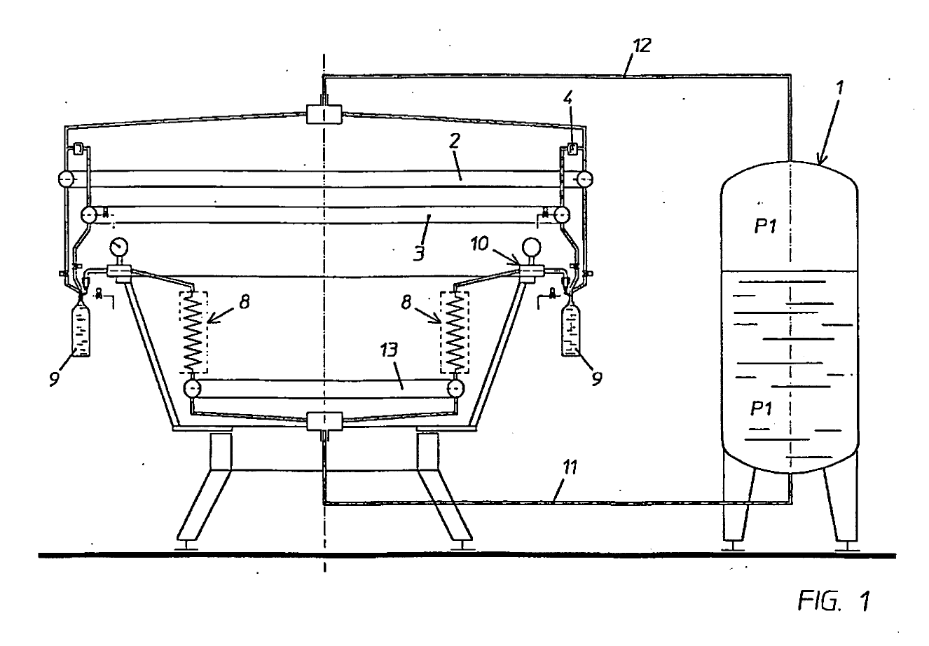

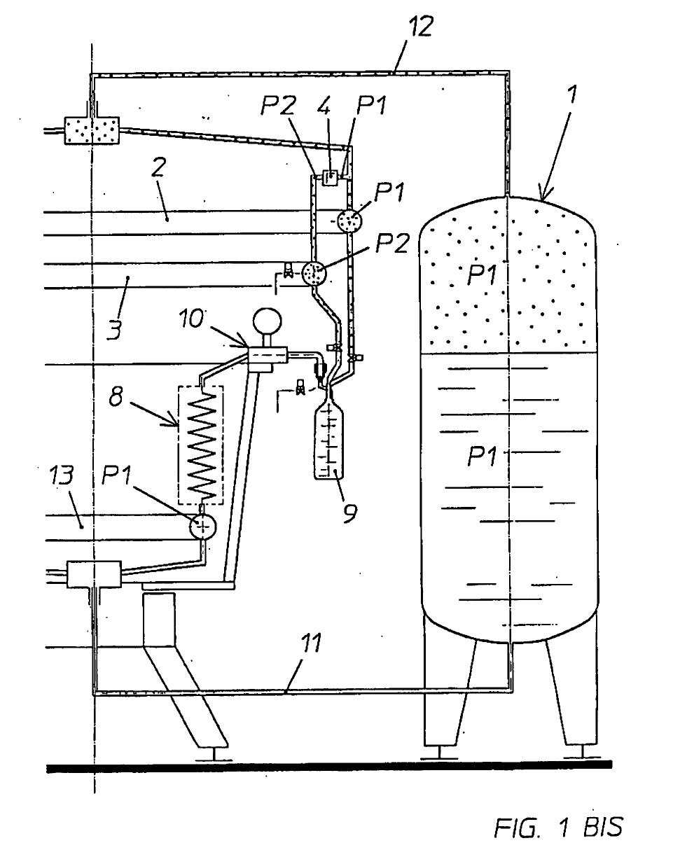

FIG. 1 represents a general scheme of the filling machine. It can be observed the presence of an external fixed tank (l)containing the processing fluids (liquid and gas) at pressure P1. It can also be noticed that the filling machine lacks a main rotating tank, but is only provided with three rotating manifolds (2, 3, 13). FIG. 1bis shows more in detail the connection of the rotating filling machine with the fixed tank (1) through the conduit (11) for the liquid and the conduit (12) for the gas. The following points must be noticed:

in the rotating manifold 13) the liquid is always at pressure P1;

in the rotating manifold (2) the gas is always at operating pressure P1;

in the rotating manifold (3) the liquid is always at lower pressure P2;

It should be noticed that the difference of pressure between manifolds (2) and (3) can be controlled through the pressure reducing valve (4).

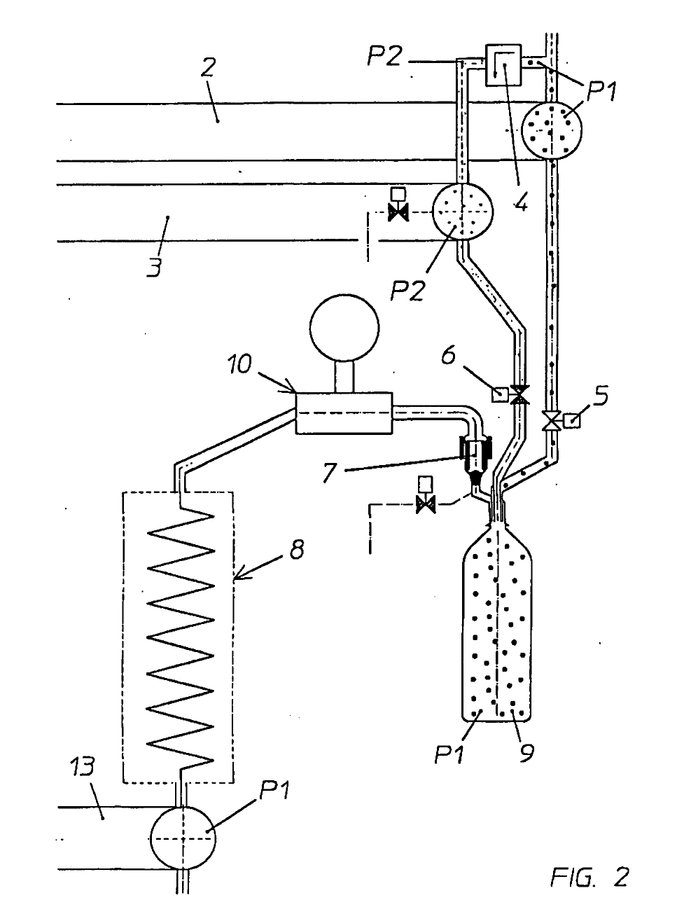

FIG. 2 shows in details the pressurizing phase of the bottle (9). One can notice that the valve (5) is open and that the gas enters to fill the bottle at pressure P1. It can also be noticed that valves (6) and (7) are closed.

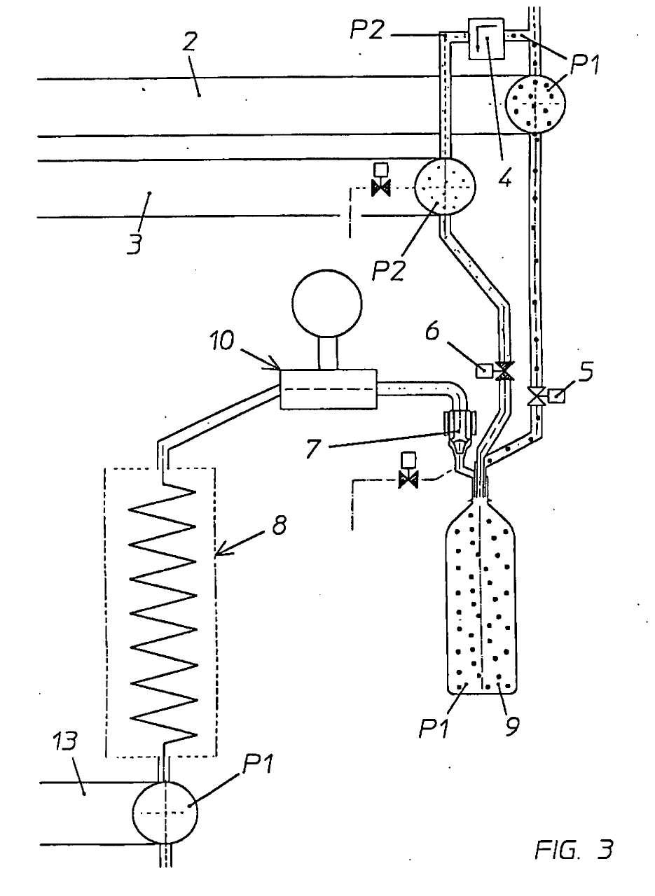

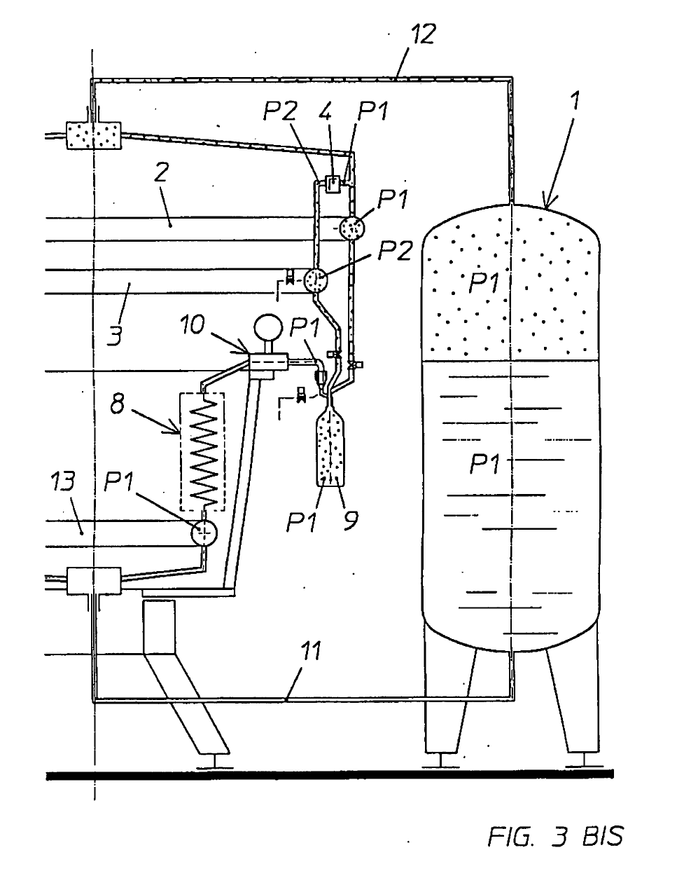

FIG. 3bis and its detail FIG. 3 show that the valve (7) is open, but the liquid at pressure P1 cannot move into the bottle because this is filled with the processing gas at the same pressure P1. It can also be noticed that the valve (6) is closed and that the gas and the residual air remain inside at pressure P1.

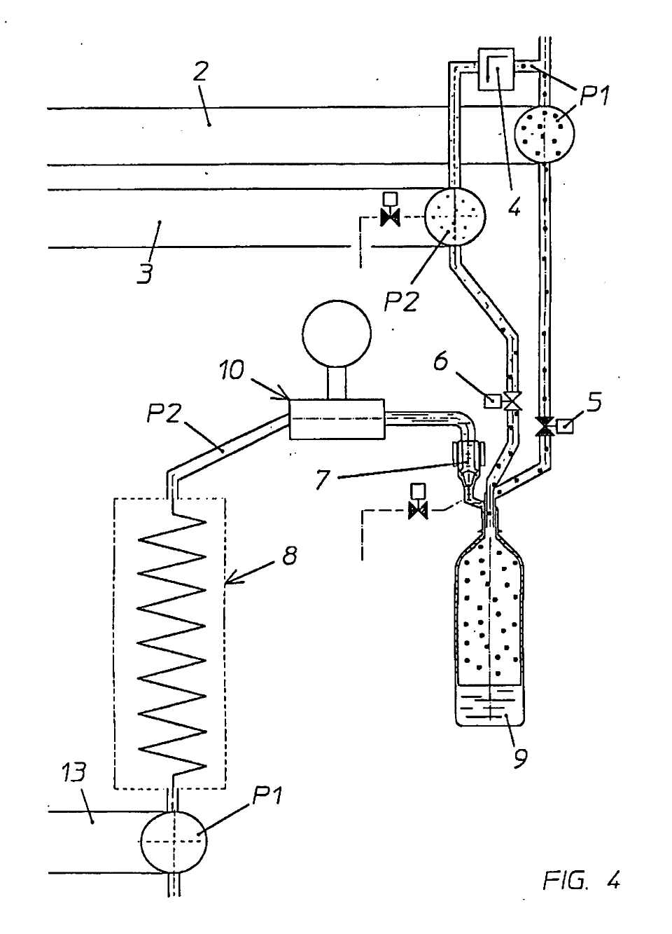

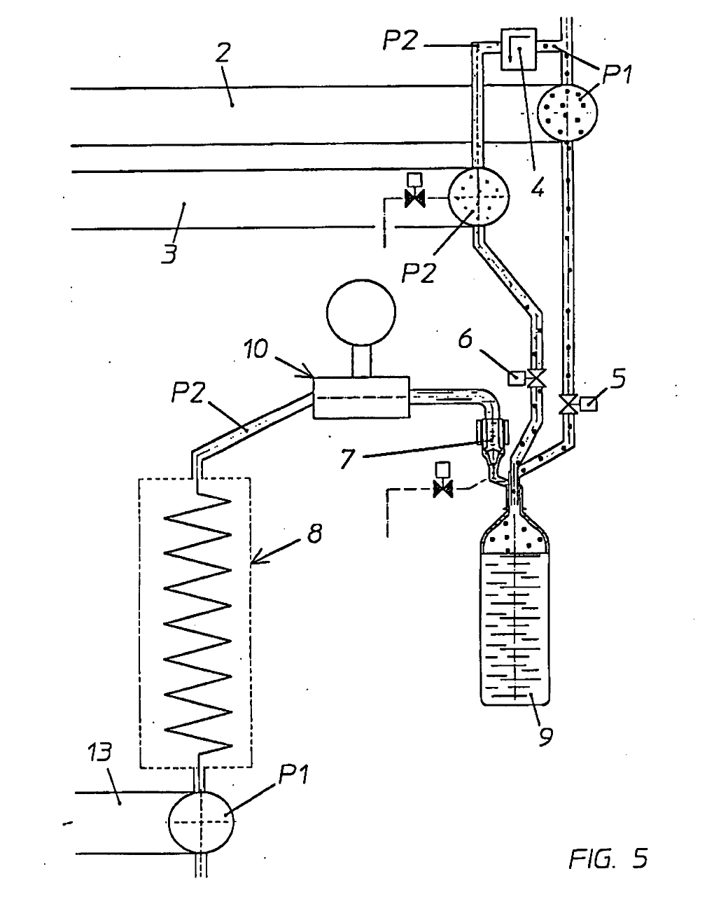

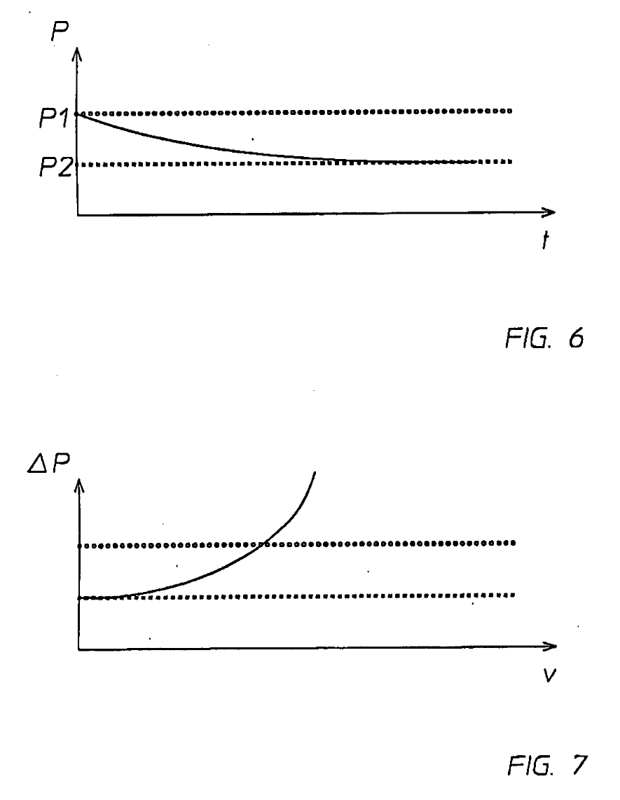

In FIG. 4 it can be noticed that after closing valve (5) and opening valve (6) the gas moves towards the rotating manifold (3) and this makes the pressure inside the bottle decrease as schematically described in FIG. 6 diagram.

As the pressure inside the bottle starts decreasing from P1 to P2, the filling phase starts, because the liquid is now at higher pressure than the bottle's pressure.

Then, as the gas pressure continues to decrease, the liquid inflow speed increases since the pressure difference causing the filling process has increased. However, the coil tube (8) generates a flow resistance that is function of the speed as shown in the FIG. 7 diagram.

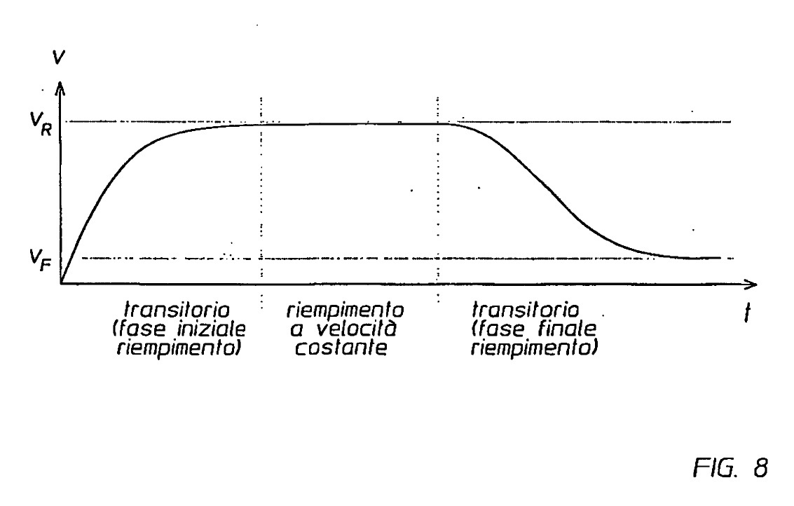

After the starting transitory phase, the filling phase of the liquid stabilizes at speed value in which the flow resistance equals the difference between pressure P1 and P2, as schematically shown in FIG. 8 diagram.

FIG. 5 shows the final transitory phase of the filling process. It can be noticed that valve (5) is open such as valve (6). In this phase, the gas at pressure P1 enters the bottle's neck while the gas inside the bottle flows out through valve (6). Inside the bottle the pressure rises and tends to stabilize at an intermediate level between P1 and P2. This pressure increment inside the bottle slows down the filling speed as schematically shown in FIG. 8 diagram.

In FIG. 6 is schematically shown the gradual pressure decrement as a function of time from value P1 to P2.

In FIG. 7 is schematically shown the flow resistance increment inside the coil tube (8) as a function of the outflow speed.

FIG. 8 indicates the filling speed as a result of the characteristics shown in FIGS. 6 and 7.

It can be noticed that during the initial transitory phase the speed increases until it reaches a constant value and in the final transitory phase it decreases to a lower final value.

In the figures each single detail of the plant is marked as follows:

1 indicates the fixed tank containing the processing fluids at P1 pressure.

2 indicates a rotating manifold containing the processing gas at P1 pressure.

3 indicates a rotating manifold containing the processing gas at lower P2 pressure.

4 indicates a device to reduce the pressure from value P1 to P2.

5 indicates a gas intercepting valve between bottle (9) and manifold (2).

6 indicates a gas intercepting valve between bottle (9) and manifold (3).

7 indicates the valve that intercepts the filling liquid.

8 indicates the coil tube that generates the flow resistance.

9 indicates the bottle to be filled.

10 indicates a flow meter.

11 indicates a connecting conduit of the liquid between the fixed tank (1) and the rotating manifold (13).

12 indicates a connecting conduit of the gas between the fixed tank (1) and the rotating manifold (2).

13 indicates a rotating manifold that distributes the liquid to the different filling valves.

The figures clearness highlights the functional characteristics of the improved plant. These improvements can of course be realized according to different structural proportioning and to the technical choices that best suit the specific requirements of the bottling plants.

All the isobaric filling machines that present the same features as the ones described, shown and hereinafter claimed will be considered as part of the protection sphere of this invention.

1) Improvements to isobaric filling machines characterized by the fact that the processing fluids are not contained in a rotating tank but in a fixed tank (1).

2) Improvements to isobaric filling machines, as in claim 1, characterized by the fact that they include a number of coil tubes (8) in charge of generating high flow resistance during the filling of the process fluid.

3) Improvements to isobaric filling machines, as in claims 1 and 2, characterized by the fact that they include a rotating manifold (2) at pressure P1 and a rotating manifold (3) at lower pressure P2, both connected to the bottle to be filled (9).
